(19) United States
(12) Patent Application Publication
(10) Pub. No.: US 2021/0102573 A1
(43) Pub. Date: Apr. 8, 2021

(54) METHOD FOR PRODUCING A CONNECTION ELEMENT, AND CONNECTION ELEMENT

(71) Applicant: ZF Friedrichshafen AG, Friedrichshafen (DE)

(72) Inventors: Frank NACHBAR, Osnabrück (DE); Oliver BONKOWSKI, Bad Essen (DE); Frank DOBBELHOFF, Bersenbrück (DE)

(21) Appl. No.: 16/500,170

(22) PCT Filed: Apr. 10, 2018
(86) PCT No.: PCT/EP2018/059095

§ 371 Date: Oct. 2, 2019

(30) Foreign Application Priority Data
May 15, 2017 (DE) 10 2017 208 096.5

(51) Int. Cl. F16C 11/06; B60G 7/00; B62D 7/20

(52) U.S. Cl. CPC F16C 11/0619; F16C 11/0685; B62D 7/20; B60G 7/005

(57) ABSTRACT

A method for producing a connection element (1, 30), in particular for an articulated connection of components arranged in a chassis. The connection element (1, 30) is formed by a profile element (6, 31) which includes a joint portion (2), for accommodating a joint component (5), a central portion (4), and a connection portion (3). The profile element (6, 31) is formed by an arrangement of at least one first profile section (7, 32) and at least one second profile section (8, 33), which are held in position, with interlock, by at least one fixing element (9, 10), a joint component (5) is inserted, into the joint portion (2) so formed, and the profile element (6, 31) and the joint component (5) are partially overmolded with a plastic material.

This application is a National Stage completion of PCT/EP2018/059095 filed Apr. 10, 2018, which claims priority from German patent application serial no. 10 2017 208 096.5 filed May 15, 2017

### FIELD OF THE INVENTION

The invention relates to a method for producing a connection element, in particular for the articulated connection of components arranged in a chassis, wherein the connection element is formed from a profile element which comprises a joint portion for accommodating a joint component, a central portion, and a connection portion.

### BACKGROUND OF THE INVENTION

In addition the invention relates to a connection element, in particular for the articulated connection of components arranged in a chassis, wherein the connection element comprises a partially cylindrical profile element with a joint portion for accommodating a joint component, a central portion, and a connection portion.

Track rods connect the rack of a steering system to wheel carriers of a motor vehicle, so as to transmit to the wheels a steering movement applied to a steering wheel. At the ends of the track rods connection elements are arranged, which serve to compensate for spatial movements of the wheels caused by elastic movement of the wheels parallel to the steering axis. At one of their ends, the connection elements have a joint portion that accommodates a joint component. A connection portion at the other end serves to enable length adjustment of the track rod by means of an internal thread provided in the connection portion.

The connection elements are generally in the form of integral metallic components. An essential disadvantage of connection elements made of metal is that they are quite heavy, usually requiring additional finish machining during their production and also measures to protect them against corrosion. The higher weight increases the proportion of unsprung masses, which has negative consequences for the driving characteristics and also for the fuel consumption of the motor vehicle concerned. For those reasons connection elements are more and more often made as hybrid structures, i.e. a combination of a metallic material with a plastic.

From DE 10 2008 049 946 A1 a connection element in the form of a joint housing for a track rod arrangement of a motor vehicle is known. The joint housing comprises a partially cylindrical body made of plastic, which has a joint portion for accommodating a joint component, a central portion and a connection portion. In the body made of plastic individual steel inserts are embedded a distance apart. To produce the body by the injection-molding process these inserts have to be previously positioned one by one in a corresponding injection-molding die so that they can be enclosed by the plastic. The joint portion, the central portion and the connection portion are only formed during the course of overmolding the inserts.

### SUMMARY OF THE INVENTION

Starting from the prior art described above, the purpose of the present invention is now to simplify the production process of a connection element having a hybrid structure.

From the standpoint of process technology this objective is achieved, starting from the preamble of the independent claim(s), in combination with its characterizing features. From the standpoint of equipment the objective is achieved, starting from the preamble of the independent claims, in combination with its characterizing features. The dependent claims that follow in each case describe advantageous further developments of the invention.

According to the invention a method is described for the production of a connection element, the connection element being formed by a profile element. The profile element of the connection element comprises a joint portion for accommodating a joint component, a central portion and a connection portion.

The invention is now based on the technical principle that the profile element is formed by an arrangement of at least a first profile section and at least a second profile section, which are held in position with interlock by at least one fixing element, such that in the joint portion so formed a joint component is inserted, and the profile element and the joint component are partially overmolded with a plastic. The method according to the invention is a further development of the hybrid structure of chassis components. Here, in a first production step a number of metallic components are connected to one another with interlock so that they form a unit. This unit, stable in its own right, can be handled in a simple manner. Thereafter, the unit made of metallic components is placed in a die and partially overmolded with a plastic. In particular the transporting and positioning of the metallic components combined to form a unit simplifies the production step of overmolding, since that step can be more extensively automated. A further simplification of the method according to the invention can be achieved in that the at least one first profile section and the at least one second profile section are made as identical parts. That reduces the fabrication costs for their production. Furthermore, the design of the at least one first profile section and the at least one second profile section as identical parts simplifies their arrangement for forming the profile element, since they can be positioned mirror-symmetrically relative to one another.

In contrast, in the case of the joint housing known from DE 10 2008 049 946 A1 the individual components of which the joint housing is assembled are only connected to one another during the overmolding in the die, which makes it essential to arrange the individual components in the die with great precision; this is time-consuming and renders any automation at least more difficult.

Thus, thanks to the method according to the invention the precision with which functional components such as the joint component can be positioned in the joint portion is increased. Although the profile element is formed of at least two profile sections, in contrast to the joint housing known from DE 10 2008 049 946 A1,by virtue of their being joined together the joint portion, the central portion and the connection portion have already been formed, and the advantages of the hybrid structure, namely low weight and inexpensive production, are retained.

Thus, before being overmolded in the area of the at least one first and one second profile sections, which define the central portion and the connection portion of the profile element, a core is inserted between the first profile section and the second profile section. This is advantageous in order to enable the connection portion of the connection element, which can have an internal thread for the axial adjustment of the track rod, to be used.

According to an embodiment of the invention, the at least one first profile section and the at least one second profile section can be made of metal or of a plastic material other than the plastic material to be used for the overmolding. If the first profile section and the second profile section are made of metal, the metals used are preferably steel or aluminum. If the first and second profile sections are made of plastic, a high-strength plastic is preferably used. The first profile section and the second profile section have a half-shell shaped portion connected to an offset portion which connects the half-shell shaped portion to a ring-shaped portion. The mirror-symmetrical design of the two profile sections simplifies their production since theft shape is identical. In this case the two profile sections can consist of two parts or be made as one piece. In the case of one-piece production, after they are made the two profile sections are joined to one another at their opposite ring-shaped portions by a web.

In the case of two-part production, after they are made the two profile sections can be connected to one another at their opposite, ring-shaped ends, in particular in the area of a front side of the two profile sections and/or semifinished parts, by means of an interlocking connection. In that way, thanks to the interlocking connection a web-like connecting structure can be produced. In this case it is an advantage that compared with a one-piece design smaller and/or simpler tools can be used to produce the profile sections. At the same time, the web-like connection structure makes it possible when the two profile sections are assembled to one another, for them to transfer or pass on forces comparably with the one-piece design. Preferably, the first profile section has a first interlocking element and the second profile section has a second interlocking element. The two interlocking elements are designed to correspond with one another so as to enable an interlock to be formed with one another. In particular, the two interlocking elements are each in the form of web-like projections on the respective ring-shaped portion. Preferably, the interlocking elements are orientated transversely or perpendicularly to the respective ring-shaped portion or to a plane in which the ring-shaped portion lies. In particular the interlocking elements face toward one another. For example, the two interlocking elements can form a puzzle-like connection in which a tab of one of the interlocking elements engages in a corresponding tab recess designed to receive it.

To achieve high strength of the connection element, the profile element can be over-molded with a fiber-reinforced plastic. For this, various types of fibers can be used, such as carbon, glass, aramide, basalt, etc.

In accordance with a further possible embodiment of the invention, the at least one first profile section and the at least one second profile section are produced by a cutting manufacturing method. The preferred production method can be stamping or laser-beam cutting. These methods enable the first profile section and the second profile section to be produced inexpensively in large numbers, particularly since they are designed as identical components.

Alternatively to the cutting production method, the at least one first profile section and the at least one second profile section can be made by transfer molding.

It is a further feature of the invention that the at least one fixing element is pressed on the at least one first profile section and the at least one second profile section. Owing to the partially rotationally symmetrical form of the profile elements the at least one fixing element can be displaced from the connection portion and pressed onto the central portion in the area adjacent to the joint portion. It is also conceivable to press on a further fixing element, which is arranged at the end on the connection portion. The second fixing element can prevent the two profile sections from being pushed apart when the core is introduced, or from being pushed toward one another. Furthermore, the outer enveloping surface of the fixing element arranged at the end on the connection portion can have an engagement area for a tool.

In addition, to achieve the stated aim a connection element, in particular for the articulated connection of components arranged in the chassis, is claimed, wherein the connection element comprises a profile element having a joint portion for receiving a joint component, a central portion and a connection portion. Here the profile element is formed by an arrangement of at least one first profile section and at least one second profile section, wherein at least one fixing element holds the at least one first profile section and the at least one second profile section in position by interlocking means. Moreover, the joint component is accommodated by the joint portion of the profile element and the profile element and the joint component held in the joint portion are partially overmolded with a plastic layer applied in an injection-molding process.

A connection element designed according to the invention is in particular part of a wheel suspension of a motor vehicle and is in the form of an outer track-rod joint or a transverse control arm.

The invention is not limited to the combination of features indicated in the independent claims or the claims that depend on them. There are also options for combining individual features with one another provided that they emerge from the claims, the description of preferred embodiments of the invention given below, or directly from the drawings. References in the claims to the drawings by the use of indexes are not intended to restrict the protective scope of the claims.

### BRIEF DESCRIPTION OF THE DRAWINGS

Advantageous embodiments of the invention, which will be explained below, are illustrated in the drawings, which show:

FIG. 1: A schematic view of a connection element;

FIG. 2a: A schematic representation of a first profile section, viewed in perspective;

FIG. 2b: A schematic representation of the first profile section and a second profile section;

FIG. 2c: A schematic representation of the first profile section and the second profile section with a first fixing element;

FIG. 2d: A schematic representation of the first profile section and the second profile section With a second fixing element;

FIG. 2e: A schematic representation of a profile element formed from the first profile section and the second profile section with a joint component;

FIG. 2f: A schematic representation of the profile element according to FIG. 2e, with plastic overmolding;

FIG. 3: A schematic view of a connection element according to a second embodiment;

FIG. 4a: A schematic representation of a semifinished part, viewed in perspective;

FIG. 4b: A schematic representation of a first profile section and a second profile section:

FIG. 4c: A schematic representation of the first profile section and the second profile section with a first fixing element;

FIG. 4d: A schematic representation of the first profile section and the second profile section with a second fixing element;

FIG. 4e: A schematic representation of a profile element formed from the first profile section and the second profile section with a joint component; and

FIG. 4f; A schematic representation of the profile element according to FIG. 4e, with plastic overmolding.

### DETAILED DESCRIPTION OF THE PREFERRED EMBODIMENTS

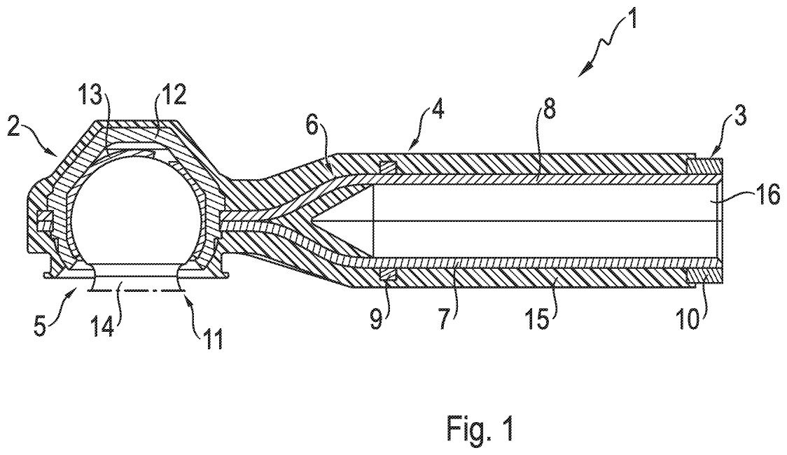

FIG. 1 shows a schematic representation of a connection element 1 in the form of an outer track-rod joint. The connection element 1 is divided into a number of portions, namely a joint portion 2, a connection portion 3, and a central portion 4 which connects the joint portion 2 and the connection portion 3 to one another. The joint portion 2 serves to accommodate a joint component 5 whereas the connection portion 3 serves to form an adjustable-length arrangement on a track rod (not shown).

The connection element is formed of a partially cylindrical profile element 6. The profile element 6 comprises at least one first profile section 7 and at least one second profile section 8. The first profile section 7 and the second profile section 8 are each partially half-shell shaped and are arranged in mirror-image relationship to one another. In the example embodiment illustrated the two profile sections 7 and 8 which form the profile element 6 are made as two separate semifinished parts. A first fixing element 9 is arranged on the central portion 4. The first fixing element 9 is essentially ring-shaped. On the connection portion 3 is arranged a second fixing element 10. The second fixing element 10 is also essentially ring-shaped. The inside contours of the first and second fixing elements 9 and 10 are shaped to fit the outer contour of the profile element 6, so that the first profile section 7 and the second profile section 8 are held in theft position with interlock.

The joint portion 2 accommodates the joint component 5, which is in the form of a ball joint 11. The ball joint 11 comprises a housing 12, a ball socket 13 arranged therein and a ball stud 14 fitted into the ball socket 13.

The profile element 6 and the housing 12 of the ball joint 11 are partially overmolded with a plastic covering 15. As can be seen from the illustration, the opening of the housing 12 out of which the ball stud 14 projects is not overmolded. The second fixing element 10 arranged on the connection portion 3 is also only partially overmolded, since the outer coating surface of the second fixing element 10 is designed to be an engagement area for a tool. In the hollow space of the profile element 6 formed by the partially half-shell shaped profile sections 7 and 8, an extractable core 16 is positioned.

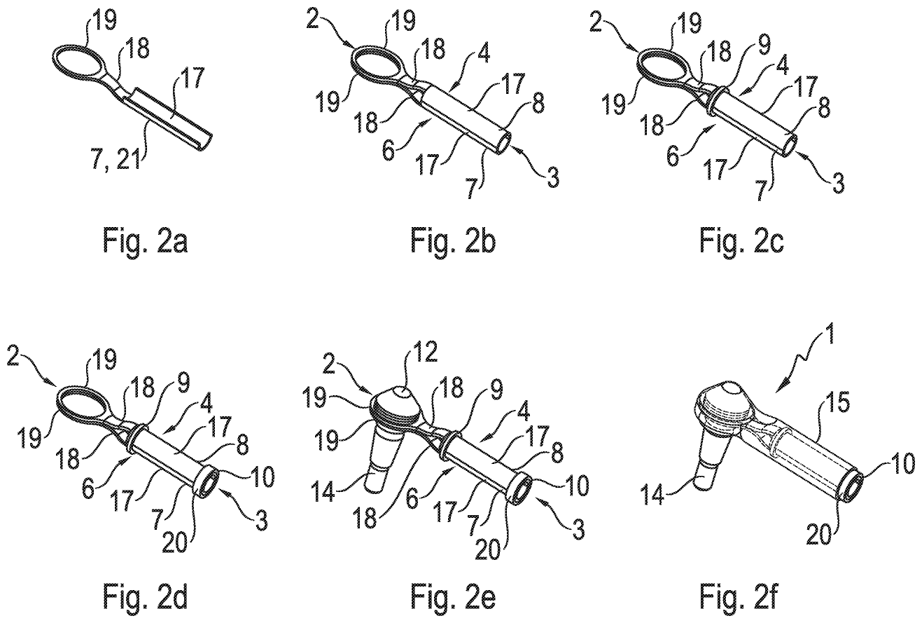

FIGS. 2a to 2f explain in greater detail the sequence of production steps of the connection element 1.

FIG. 2a shows a schematic perspective view of the first profile section 7 in the form of a semifinished part. The first profile section 7 has a half-shell shaped section 17 which is connected by an offset section 18 to a ring-shaped, flat segment 19. The first profile section 7 is produced by a cutting manufacturing method, for example by stamping or laser-beam cutting. The second profile section 8 is identically designed and is produced in just the same way.

FIG. 2b shows a schematic representation of the first profile section 7 and the second profile section 8. In a first process step the two profile sections 7 and 8 are arranged mirror-symmetrically relative to one another. The two half-shell shaped sections 17 form the connection portion 3 and the central portion 4, which open into the offset sections 18. The ring-shaped, flat segments 19 of the two profile sections 7 and 8 mutually aligned one above the other form the joint portion 2, which serves for the later accommodation of the joint component 5.

FIG. 2c shows a schematic representation of the first profile section 7 and the second profile section 8 with a first fixing element 9 arranged on them. The ring-shaped first fixing element 9 is pushed from the connection portion 3 onto the central portion 4 of the profile element 6. The inner contour of the first fixing element 9 is shaped to fit the outer contour of the central portion 4, so that an interlock is formed. In the area of the offset sections 18 of the first profile section 7 and the second profile section 8 opposite one another, the first fixing element 9 is pressed on and thereby locally fixed on the central portion 4.

FIG. 2d shows a schematic representation of the first profile section 7 and the second profile section 8 with a second fixing element 10. The second fixing element 10 is also ring-shaped and is pressed onto the end of the connection portion 3. At its periphery the second fixing element 10 has at least two tool engagement areas 20.

FIG. 2e shows a schematic representation of the profile element 6 formed of the first profile section 7 and the second profile section 8, with the joint component 5 arranged in the joint portion 2. After this production step all the individual components of the connection element 1 are connected to one another in such manner that the individual components can be handled as a single unit 22 stable in its own right. Into the hollow space formed between the first profile section 7 and the second profile section 8 is inserted a core 16. In that way some space is kept free, which must be available during the later use of the connection element 1. The unit 22 is placed in an injection-molding die and partially overmolded with a plastic, so that a covering of plastic 15 that surrounds part of the unit 22 is formed, as shown in FIG. 2f. The finished connection element 1 is more inexpensive and has lower weight than a comparable connection element made of metal in one piece. Compared with the method of the prior art known from DE 10 2008 049 946 A1, according to which individual steel inserts are embedded in a body consisting of plastic, each of them having to be placed individually in the injection-molding die, the ability of the unit 22 forming a stable composite to be handled provides a simpler solution. The individual components of the unit have already been positioned relative to one another before insertion into the injection-molding die.

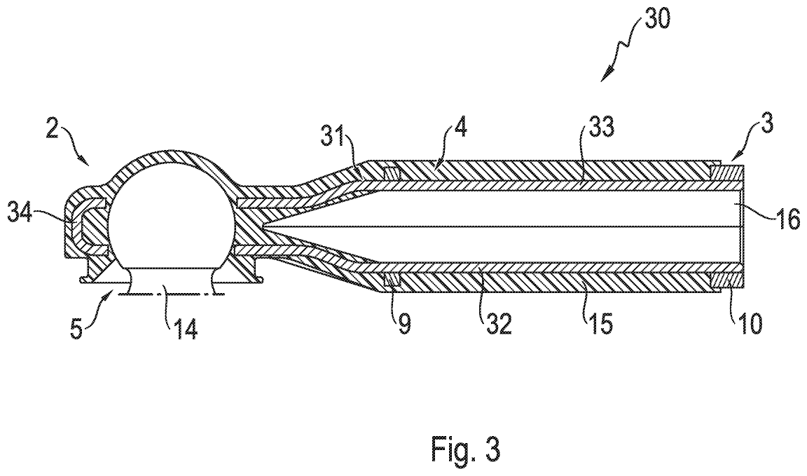

The representation in FIG. 3 shows a schematic view of a connection element 30 according to a second embodiment. The same indexes are retained for components identical to those in the connection element 1 according to the first embodiment.

The connection element 30 is formed by a partially cylindrical profile element 31. The profile element 31 comprises a first profile section 32 and a second profile section 33. The first profile section 32 and the second profile section 33 are in each case partially half-shell shaped and are arranged mirror-symmetrically relative to one another. In the forward area of the joint portion 2 the two profile sections 32 and 33 are connected to one another by a web 34. In the example embodiment illustrated, the first profile section 32 and the second profile section 33 which form the profile element 31 are produced as a single semifinished part.

Alternatively, the web 34 can be made in two parts so that the first profile section 32 and the second profile section 33 each have a web-like interlock element which are designed to correspond to one another in order to form an interlock with one another.

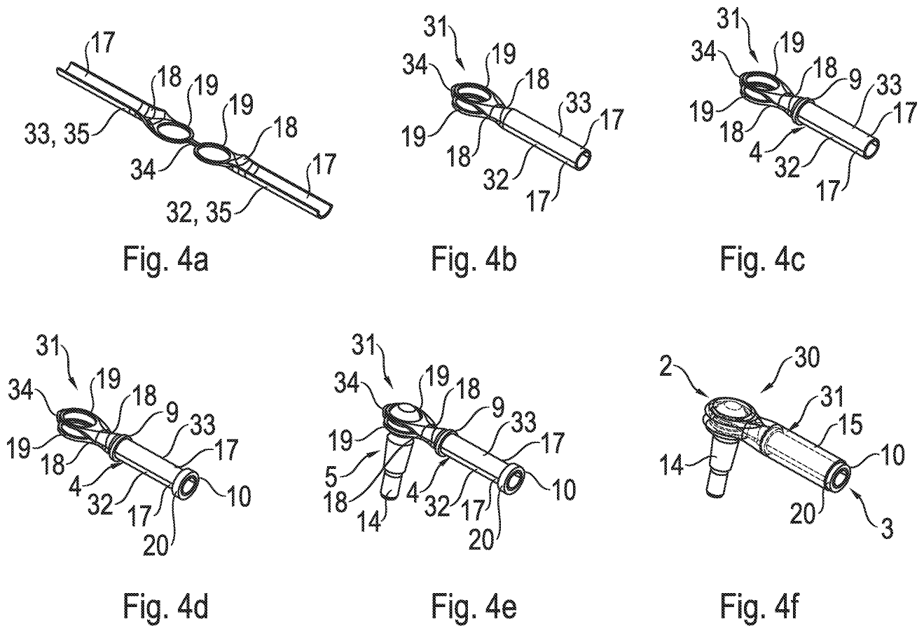

FIG. 4a shows a schematic representation of a semifinished part 35, viewed in perspective. The semifinished part 35 comprises the first profile section 32 and the second profile section 33 connected thereto by the web 34. In a first step the semifinished part 35 is deformed by bending. In that way the first profile section 32 and the second profile section 33 are arranged mirror-symmetrically relative to one another, as shown in FIG. 4b. After the deformation of the two profile sections 32 and 33, the web 34 extends essentially perpendicularly between them.

FIG. 4c shows a schematic representation of the first profile section 32 and the second profile section 33 with the first fixing element 9 pushed onto the central portion 4 of the profile element 31. As already explained earlier, due to the fit between the shapes of the outer contour of the two profile sections 32 and 33 and the inner contour of the enveloping surface of the first fixing element 9, an interlocking connection is formed. The fixing element 10 is then pressed onto the profile element 31.

FIG. 4d shows a schematic representation of the first profile section 32 and the second profile section 33 with the second fixing element 10, which is pushed onto the connection portion 3 of the profile element 31. The fixing element 10, provided at its periphery with at least two tool engagement areas, is pressed onto the profile element 31.

FIG. 4e shows a schematic representation of the profile element 31 formed of the first profile section 32 and the second profile section 33, with a joint component 5 in the form of a ball stud 14. The ball of the ball stud 14 is held by the two ring-shaped, flat segments 19, The core 16 is inserted into the hollow-cylindrical central portion 4. The unit 22, consisting of a stable composite, is placed in the injection-molding the and partially overmolded with plastic to form the plastic covering 15.

FIG. 4f shows a schematic representation of the profile element 31 as in FIG. 4e, with the plastic covering 15. In the area of the joint portion 2 the plastic covering 15 forms a housing for the ball of the ball stud 14. To overmold the profile element 6 or 31, a plastic or fiber-reinforced plastic is used. Correspondingly, the injection-molding processes for producing the connection elements 1 or 30 may differ from one another.

A further development provides that the profile element 6 or 31 is also made of a plastic instead of from a metal such as steel or aluminum. In such a case at least the plastic used for the profile element 6 or 31 is different from the plastic used for overmolding the profile element 6 or 31. In particular, a high-strength plastic is used for the profile element 6 or 31.

### INDEXES

1 Connection element
2 Joint portion
3 Connection portion
4 Central portion
5 Joint component
6 Profile element
7 First profile section
8 Second profile section
9 First fixing element
10 Second fixing element
11 Ball joint
12 Housing
13 Ball socket
14 Ball stud
15 Plastic covering
16 Core
17 Half-shell shaped section
18 Offset section
19 Ring-shaped segment
20 Tool engagement area
21 Semifinished part
22 Unit
30 Connection element
31 Profile element
32 First profile section
33 Second profile section
34 Web
35 Semifinished part

1-12. (canceled)

13. A method of producing a connection element (1, 30), the connection element (1, 30) having a profile element (6, 31), which includes a joint portion (2) for accommodating a joint component (5), a central portion (4), and a connection portion (3), the method comprising:
forming the profile element (6, 31) by an arrangement of at least one first profile section (7, 32) and at least one second profile section (8, 33),
holding the at least one first profile section and the at least one second profile section in position, with interlock, by at least one fixing element (9, 10),
inserting the joint component (5) into the joint portion (2) so formed, and
partially overmolding the profile element (6, 31) and the joint component (5) with a plastic material.

14. The method according to claim 13, further comprising prior to overmolding in an area of the at least one first and the second profile sections (7, 32; 8, 33), which defines the central portion (4) and the connection portion (3) of the profile element (6, 31), inserting a core (16) between the first profile section (7, 32) and the second profile section (8, 33).

15. The method according to claim 13, further comprising forming the at least one first profile section (7, 32) and the at least one second profile section (8, 33) from either a metal or another plastic material that is different from the plastic material used for the overmolding.

16. The method according to claim 13, further comprising overmolding the profile element (6, 31) with a fiber-reinforced plastic.

17. The method according to claim 13, further comprising producing the at least one first profile section (7, 32) and the at least one second profile section (8, 33) by a cutting manufacturing method.

18. The method according to claim 13, further comprising producing the at least one first profile section (7, 32) and the at least one second profile section (8, 33) by transfer molding.

19. The method according to claim 13, further comprising pressing the at least one fixing element (9, 10) onto the at least one first profile section (7, 32) and the at least one second profile section (8, 33).

20. A connection element (1, 30) for an articulated connection of components arranged in a chassis, the connection element (1, 30) comprising:
a profile element (6, 31), which has a joint portion (2) for accommodating a joint component (5), a central portion (4), and a connection portion (3),
the profile element (6, 31) being formed by an arrangement of at least one first profile section (7, 32) and at least one second profile section (8, 33),
at least one fixing element (9, 10) holding the at least one first profile section (7, 32) and at least one second profile section (8, 33) in position, with interlock, and
the joint portion (2) of the profile element (6, 31) accommodating the joint component (5), and
the profile element (6, 31) and the joint component (5), accommodated in the joint portion (2), being partially overmolded with a plastic material applied by an injection-molding process.

21. The connection element (1, 30) according to claim 20, wherein the at least one first profile section (7, 32) and the at least one second profile section (8, 33) are of a half-shell shaped design.

22. The connection element (1, 30) according to claim 20, wherein the connection element (1, 30) is designed either as a track-rod outer link or a transverse control arm.

23. The connection element (1, 30) according to claim 20, wherein the joint component (5) is either a ball joint (5) or a ball stud (14).

24. The connection element (1, 30) according to claim 20, wherein the connection element is formed by a method including:
forming the profile element (6, 31) by the arrangement of the at least one first profile section (7, 32) and the at least one second profile section (8, 33),
holding the at least one first profile section and the at least one second profile section in position with interlock by the at least one fixing element (9, 10);
inserting the joint component (5) into the joint portion (2) so formed; and
partially overmolding the profile element (6, 31) and the joint component (5) with the plastic material.

25. A method of producing an articulated connecting element which connects components arranged on a chassis of a motor vehicle, the method comprising;
arranging at least one first profile section and at least one second profile section to form a profile element having a joint portion, a central portion, and a connection portion;
interlocking the at least one first profile section and the at least one second profile section with one another by at least one fixing element;
inserting a joint component into the joint portion of the profile element; and
partially overmolding the profile element and the joint component with a plastic material to form the connecting element.
